(19) United States
(12) Patent Application Publication
(10) Pub. No.: US 2005/0132408 A1
(43) Pub. Date: Jun. 16, 2005

(54) System for controlling a video display

(76) Inventors: Andrew Dahley, San Francisco, CA (US); Victor C. Su, Palo Alto, CA (US); Scott S. Snibbe, San Francisco, CA (US); Thomas Niergarth, Zeeland, MI (US); Paul M. Yarin, Tenafly, NJ (US); Irving S. Scher, Los Angeles, CA (US)

Correspondence Address: BRINKS HOFER GILSON & LIONE, P.O. BOX 10395, CHICAGO, IL, 60610, US

(21) Appl. No.: 10/853,743

(22) Filed: May 25, 2004

Related U.S. Application Data
(60) Provisional application No. 60/474,789, filed on May 30, 2003.

(51) Int. Cl. H04N 7/173; H04N 7/18; H04N 7/14

(52) U.S. Cl. 725/80; 725/81; 725/109; 725/110; 348/14.01

(57) ABSTRACT

A system is disclosed for controlling multiple input devices, such as VCRs, DVD players and videoconferencing equipment, and at least one output device, such as a projector and a monitor, in a video presentation system. The system includes a processor connected to a user control interface, the multiple input devices and the at least one output device. The user interface is a unified control system for the input and out put devices. A user can select through the user control interface one of the input devices. The processor can determine and control an operating state of the input device, and control the operating state of the at least one output device. The processor can also control the connection of the input device to the output device.

### CROSS-REFERENCE TO RELATED APPLICATION

This application is a continuation of U.S. patent application Ser. No. 60/474,789, filed May 30, 2003, which is incorporated by reference herein.

### FIELD OF THE INVENTION

This invention generally relates to control systems, and more particularly relates to an aggregated control system for controlling video displays, and preferably for controlling audio output and environmental systems as well.

### BACKGROUND

The way to conduct meetings in the workplace is changing. There no longer exists merely one or two ways to make a presentation. Meetings, presentations and collaboration such as video conferencing, are becoming more elaborate. At the meetings, typically large amounts of information are presented in a variety of ways and the information may be presented by multiple presenters. There is a need for a meeting environment that is more dynamic and flexible.

While technology provides a variety of useful tools such as laptops and audio and visual equipment, the technology can often become a barrier to conducting a successful meeting. Power, data, video and other connections are not always easily accessible. The presenters often want to use the variety of tools together, yet the tools are often designed to be used separately. Control devices such as universal remote controls only send control commands directly to individual devices. The remote controls are not capable of ascertaining the state of a device, but rather can only repeatedly send commands to a single component. This leaves the control of individual components to the user creating a great deal of complexity and potential problems to deal with.

Complex multi-step procedures for controlling several different components are needed to accomplish basic functions. This creates many possible points of failure in the system functionality and requires the user to have a great deal of detailed knowledge about the interconnectivity of the system components. A large amount of time and money is spent designing, specifying, maintaining and using the variety of devices. Those that invest much of the time and money include architects and interior designers, facility managers, information technology managers, and end users such as the presenters.

Typically meetings take place in a shared space, such as a conference room. There is not usually a person assigned to managing and maintaining equipment in the meeting place. Information technology managers have other priorities. Facility managers view video conferencing as someone else's problem. A lot of time and effort is used to set up and reconfigure the system. Managing and rewiring the cables can be cumbersome. Necessary maintenance and upgrades to the equipment are neglected.

There is a need for an audio and video presentation environment that can be easy to maintain and easy to use.

### BRIEF SUMMARY

A system is disclosed for controlling multiple input devices and at least one output device in a video presentation system. The system includes a user control interface, a processor connected to the user control interface, multiple input devices and at least one output device. The processor is operable through the user control interface to select one of the input devices, determine the operating state of the selected input device, control an operating state of the selected input device, and determine and control the operating state of the at least one output device in accordance with the determined operating state of the input devices and the at least one output device.

Other systems, methods, features and advantages of the invention will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The invention can be better understood with reference to the following drawings and description. The components in the figures are not necessarily to scale, emphasis instead being placed upon illustrating the principles of the invention.

FIG. 1 is a diagram illustrating an audio and video presentation system and control system using aggregated control and an exemplary environment in which the system can be implemented.

FIG. 2 is a block diagram of a centralized arrangement of the control system.

FIG. 3 is a block diagram of a decentralized arrangement of the control system.

FIG. 4 illustrates a perspective view of an example user control device such as a user control unit device.

FIG. 5 is a screen shot of an example on-screen user interface that can be displayed on a monitor.

FIG. 6 is a flowchart illustrating a user control of operation of the video inputs.

FIG. 7 is a flowchart illustrating a user activating the user interface.

FIG. 8 is a flowchart illustrating a user using the control system to obtain a snapshot or video.

FIG. 9 is a flowchart illustrating user control of the volume of audio systems of the control system.

FIG. 10 is a flowchart illustrating user control of the mute of audio systems of the control system.

FIG. 11 is a flowchart illustrating a user, such as system administrator, accessing system configuration information of the control system.

FIG. 12 is a flowchart illustrating power down functions of the control system.

FIG. 13 is a flowchart illustrating a use of the video camera settings of the control system.

FIG. 14 is a flowchart illustrating a use of an ID card to perform functions with the control system.

FIG. 15 is a flowchart illustrating a use of an ID card to perform an image capture function with the control system.

FIG. 16 is a block diagram illustrating control hardware to perform the functions offered by the user control unit of FIG. 4.

FIGS. 17A and 17B is a flowchart illustrating an operation of exemplary firmware run by the microcontroller of the hardware of FIG. 16.

FIG. 18 is a block diagram illustrating a software architecture of the control system.

FIG. 19 is a flowchart illustrating the beginning of execution of the control system.

FIG. 20 is a flowchart illustrating tasks performed at each timer interval.

FIG. 21 is a flowchart illustrating a control module timer tick sequence.

FIG. 22 is a flowchart illustrating a control system refresh user interface sequence.

FIG. 23 illustrates an initialize device sequence that can be executed for each device in the sequence.

FIG. 24 is a block diagram illustrating exemplary wiring to an input/output analog/video switch.

Table of Acronyms

The following table can aid the reader in determining the meaning of the several acronyms used herein:
CRT=Cathode Ray Tube.
DVD=Digital Video Disc.
EEPROM=Electronically Erasable Programmable Read Only Device.
GUI=Graphical User Interface.
HDTV=High Definition Television.
ID=Identification.
IEEE=Institute of Electrical and Electronics Engineers.
I/O=Input/Output.
IR=Infrared.
LAN=Local Area Network.
LCD=Liquid Crystal Display.
LED=Light Emitting Diode.
PC=Personal Computer.
PDA=Personal Digital Assistant.
RGB=Red Green Blue.
RF=Radio Frequency.
UI=User Interface.
USB=Universal Serial Bus.
VCR=Video Cassette Recorder.
WAN=Wide Area Network.
WiFi=Wireless Fidelity.
WLAN=Wireless Local Area Network.

### DETAILED DESCRIPTION

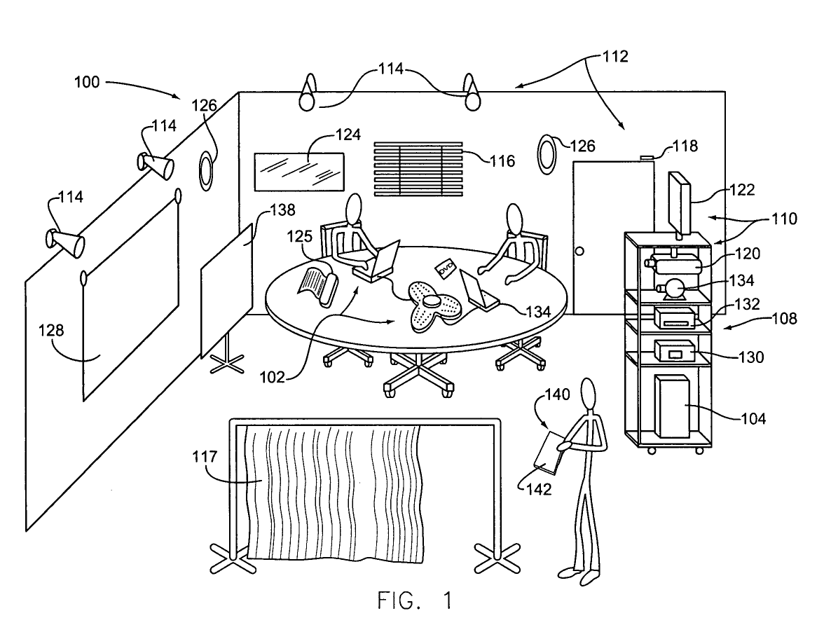

FIG. 1 is a diagram illustrating an audio and video presentation system and control system using an aggregated control, with a unified user control interface for all system devices and an environment in which the systems, hereinafter collectively referred to as the control system 100, can be implemented. The control system 100 can be implemented in different environments such as at home and in the workplace. The control system 100 includes one or more user control devices 102 connected with a processor 104. The processor 104 and the user control devices 102 can be separate or integrated together. The processor 104 is used to monitor and/or otherwise determine the state of and control input devices 108 and output devices 110 such as those used for audio and video presentations. The state of the devices 108, 110 include on/off states, power, the current operating function such as playing, paused and rewinding, and other functional states of the devices. The processor 104 can also controls a video switch matrix that is used to connect video output devices 108 with audio and video signals from the input devices 108. The processor 104 can receive inputs from and control devices other than audio and video components 226, such as environmental devices 112, including actuators, sensors, lighting systems, and projection screens.

Components within the control system 100 can vary. Environmental devices 112 include lights 114, window shades 116, movable screening 117 and other devices including sensors 118, such as motion sensors, heat sensors and door sensors, which can be used to sense and/or control the environment. Output devices 110 include projectors 120, monitors 122, including cathode ray tube (CRT) monitors, plasma screens 124, printers 125 and speakers 126. The projector can project images onto a screen 128. Input devices 108 include playback devices including video cassette recorders (VCR) 130 and digital video disk (DVD) players 132. Input devices 108 also include processors such as personal computers (PC), portable computers 134 and tablet PCs. Input devices also include other devices such as a camera 134 used in teleconferencing. The camera 134 can be directed at devices within the environment such as whiteboard 138. User control devices 102 include hardware devices and software devices, including tabletop devices, handheld devices and computing devices.

Input from other components 226, such as sensors, within the environment or any other data sources can be used in the control logic of the control system 100. Actuators and other devices can also be controlled based on any desired behavior or user input configured into the control software. For example, when a user enters a room controlled by the control system 100, the control system 100 can be programmed to automatically turn on the lights 114. If the user powers the VCR 130, the control system 100 can be programmed to determine the state of the lights 114 and shades 116, and automatically dim the lights 114, if on, and close the shades 116, if open. Moreover, if the control system 100 determines that the DVD player 132 is already playing, the control system 100 can automatically turn off the DVD player 132 when turning on the VCR player 130. Further, if a person starts writing on the whiteboard 138, a motion sensor in the vicinity can detect this and swivel a video camera, such as camera 134, to capture the image. Moreover, if a speaker phone 214 is being used while a video is being displayed, the audio from the tape or DVD can be routed to both the speakers in the room and an audio input of the speaker phone 214.

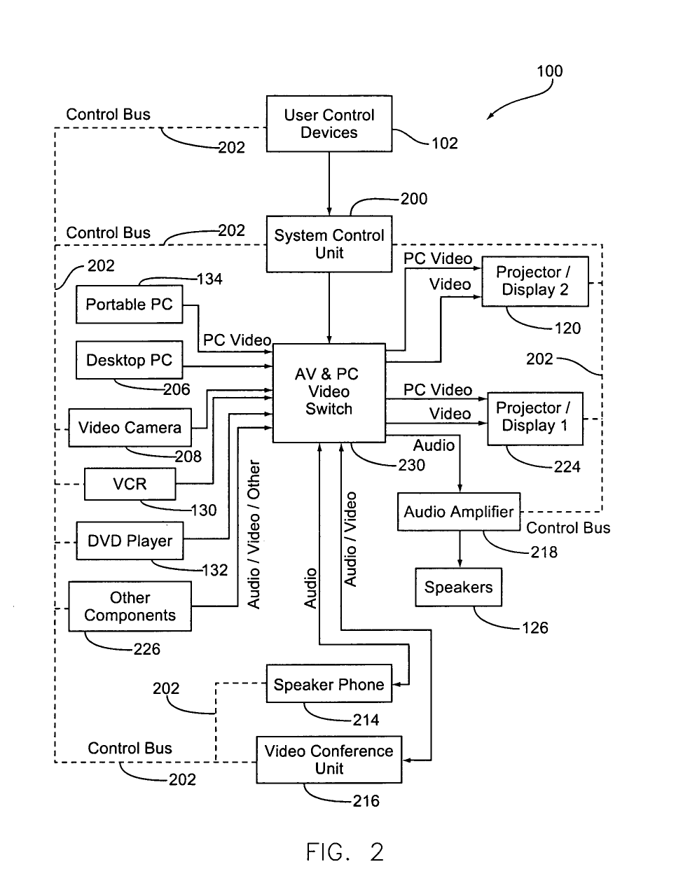

FIG. 2 is a block diagram of a centralized arrangement of the control system 100. The processor 104, such as a system control unit 200, connects with equipment via a control bus 202. The connection can also be a direct serial port connection to each device. As used herein, the term connected can include both direct and indirect connections, e.g. connected via direct electrical connections, infra-red connections, Ethernet and other communication protocols, wireless protocols, such as 802.11b, or a chain of protocols, such as Ethernet to wireless and Ethernet to infra-red, or serial. A system user can control equipment with one or more user control devices 102, described in more detail below, which communicate with the system control unit 200 via the control bus 202. The control bus 202 allows for two-way communication between system control unit 200 and the equipment.

The control system 100 facilitates the use of disparate equipment, such as devices and components, connected with the control system 100. The user controls equipment via the interface 102 such as the portable PC 134, including a laptop, a tablet PC and a graphical user interface (GUI), and/or a stationary PC, including a desktop PC 206. Other possible user control interfaces can include personal digital assistants (PDA's), infrared remote control, a PC keyboard, a mouse and a video panel 140. The video panel 140 can be portable such that it is battery powered and can connect to the control system 100 via wireless communication. The video panel 140 can include a touch screen display 142 which allows the user to touch the screen to determine inputs. Upon a command by a user, or automatically, such as at a specified time, the processor 104 controls equipment including the web camera 134, a video camera 208, a VCR 130 and/or a DVD player 132. The control system 100 can also include communication equipment such as a telephone, including a speaker phone 214 and a video conferencing unit 216, which can be controlled by the processor 104. When needed, audio equipment such as and audio amplifier 218 and speakers 126 can be connected with input devices 108 to display audio output from the personal computer, the VCR 130, the DVD player 132, and other system such as the videoconferencing system. Video signal from the input devices 108 can be automatically connected with and displayed by one or more projectors 120 and/or video displays 224, or on projector screens 128, monitors 122, and televisions. Other components 226 can also be controlled or monitored, such as lighting, heating, cooling equipment and sensors. The sensors can include occupancy sensors to determine whether a user is present in a room. The processor 104 can be programmed to automatically control the state of equipment within the room when a user enters or leaves the room, for example by considering output signals from motion sensors or other sensory methods.

The control system 100 can include a video scaler and an audio or video switch or an audio and video switching device 230. An exemplary switching device is an input/output (I/O) switch manufactured by Extron Electronics, located in Anaheim, Calif. In addition, a series of I/O or other switches could be used. The switch 230 can be integrated in the processor 104 and/or a separate device. The switch 230 accommodates making connections between the input devices 108 and any number of the output devices 110 at the direction of the processor 104. An exemplary switch 230 can route both analog video signals, e.g., originating from a VCR and television receiver, and red-green-blue (RGB) video signals, e.g., originating from a computer monitor, high definition television (HDTV) and other RGB source. To conform the input device 108 and output device 110, a video scaler processes the video output from an analog video source to be displayed on an RGB monitor 122 or projector 120. The video scaler allows resealing video for output devices 110 that are not capable of displaying the video format from the input source 108.

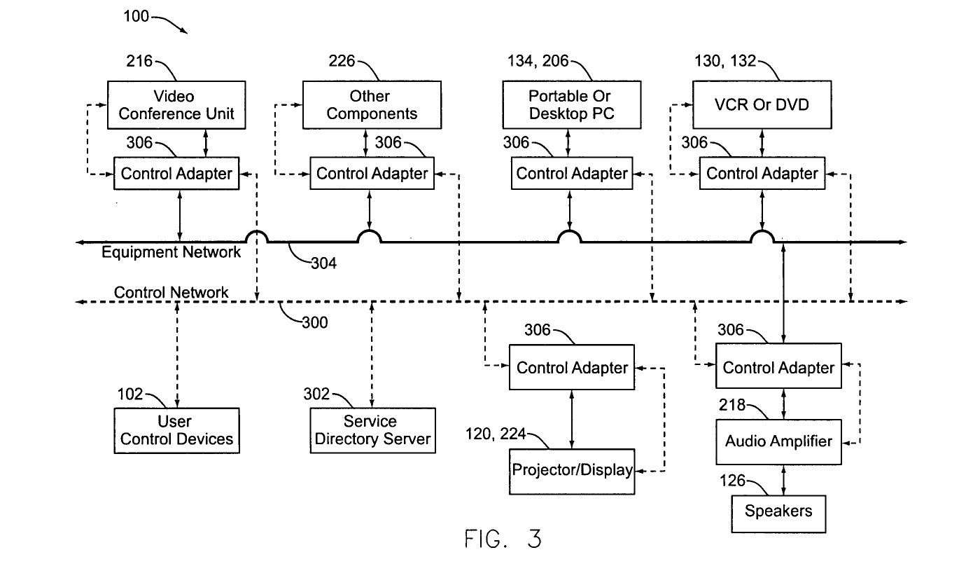

FIG. 3 is a block diagram of a decentralized arrangement of the control system 100. The decentralized control system allows the user to control equipment at locations other than a location of the user. User control devices 102 connect with equipment via a control network such as a local area network (LAN), the Ethernet, a telecommunications network, such as a cellular network and a landline, and/or a wide area network (WAN), such as the Internet. The user control devices 102 connect with a service directory server 302 to determine available devices and appropriate interface protocols. The service directory server 302 registers available devices on the network. Registered input devices can dynamically connect with required output devices. This control can be used to monitor and change the states of the equipment, such as the video conference unit 216. The equipment is connected to an equipment network 304 via a control adapter 306. This control adapter communicates with the control system over the equipment network and translates commands to the input requirements of the device to be controlled. The control adapter 306 may be integrated with the equipment or connected to the equipment as a separate component for compatibility with current non-network capable devices. The control adapter 306 also connects to the control network 300 to accommodate the monitoring and control commands of the equipment. The network buses (304 and 300) could also be consolidated into a shared bus for both data signals and control rather than separate data and control networks.

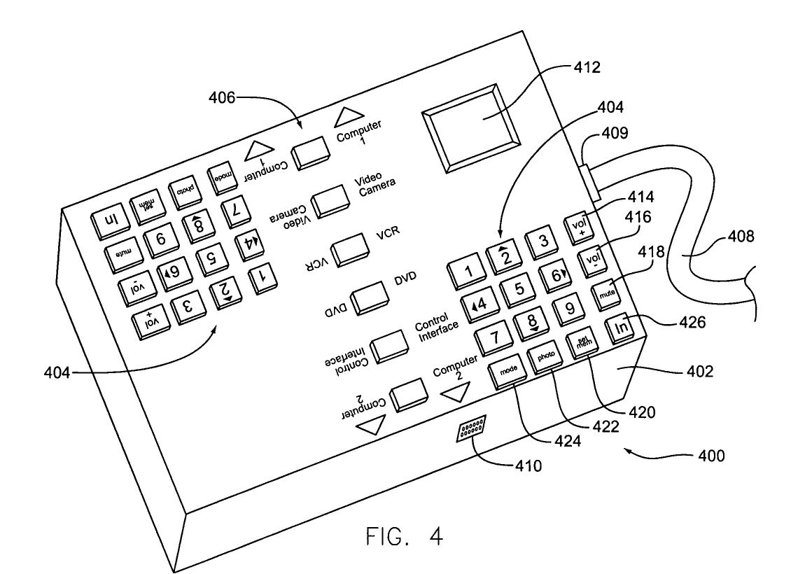

FIG. 4 illustrates a perspective view of an example user control device 102 such as a user control unit 400. The user control unit 400 includes an enclosure 402. The enclosure 402 is shown with a generally rectangular shape but can include other shapes, such as generally spherical or triangular shapes. The user control device 102 can also be incorporated into other devices such as a speaker phone. The user control unit 400 can include one or more user interfaces including keypads 404, such as alphanumeric keypads. Multiple keypads 404 can be provided such that one or more users could utilize the user control unit 402 while being positioned on opposite sides of the user control unit 402.

For ease of operation, the user control unit 400 can also include other user interfaces such as input device buttons 406 that correspond to inputs 108 such as equipment controlled with the user control unit 400. Such equipment includes one or more computers such as a laptop or tablet PC, video cameras, VCRs DVD players and control interfaces. When the user presses one of the input device buttons 406, the video signal from the equipment corresponding to that button is automatically routed to a designated output device 110. The output device 110 can be designated by the user, a manufacturer, a distributor or others with hardware, software and/or firmware, discussed more below.

The user control unit 400 can also include an identification tag reader 412, such as a radio frequency (RF), infrared (IR) and/or bar code reader or other identification technology such as thumb print reader. The reader allows the user to activate a feature of the control system 100, such as to control equipment with the control system 100. To activate a feature of the control system 100, the user positions a device by the reader, such as an identification (ID) card. The ID card can include conventional card shapes and other shapes such as a wand shape. The ID card can be labeled with indicia, such as “PLAY DVD,” so that the user can easily determine which functions the ID card controls.

The specific functions to perform or a unique identifier representing the functions can be stored on the ID card and/or printed on the ID card such as in the form of a bar code. If an identifier is used, the processor 104 can access a database, such as a lookup table, to determine the function that corresponds to the identifier stored on the ID card. The ID cards can be programmed to include user preferences, such as opening a web browser on a PC of the user to connect with the Internet. User preferences can be stored and changed on a memory of the ID card such as with an electronically erasable programmable read only device (EEPROM). The ID card can be incorporated into a building ID card of the user.

The user control unit 400 can accommodate various connectors. The equipment can connect with wires, such as via wiring harness 408 and/or via a wireless connection, such as Wireless Fidelity (WiFi) or a wireless local area network (WLAN). The wiring harness 408, or a cable that can accommodate multiple signals, allows for a single cable connection point 409 to the user control unit 400. The user control unit 400 can also include input ports 410, such as universal serial bus (USB) ports or IEEE-1394 ports which allow the user to connect to the user control unit with a computer. Other input ports 410 can also be used, such as those that accommodate a fifteen pin RGB Video HD15 plug, a nine pin serial DB9 plug, a twenty nine pin DVI plug, RCA audio inputs, an eight to ten pin RJ45 plug for (Ethernet network connection) and a four pin RJ11 plug for phone connection. In addition the user control unit 400 can include A/C power outlets to power laptop computers or other devices requiring power, and can be setup to accommodate custom cables.

The user control unit 400 provides the user with controls to operate certain functions of the equipment, such as controlling an audio level output by speakers 220 and the brightness and contrast of a video display. The user control unit 400 can include other buttons and controls, such as an up volume button 414, a down volume button 416 and a mute button 418. The number keys can be set to preset functions, such as up to nine preset camera positions. The camera positions can be set engaging a set memory button 420 and then pressing a key located on a number pad, such as keys 1-9. The user can then recall the camera position by pressing the number. To share information with other users, the video camera can be positioned at different positions within a workspace such as at a white board, a blackboard, a projector screen or a participant of a meeting. A photo button 422 can be used to take a photo, such as a digital photo, of a current view of the video camera, or for other functions such as saving a current screen being displayed. The photo can be saved to memory such as a memory of the control system 100 or a PC server on the computer network. The user control unit 400 can also include a mode button 424, such as to change a mode of the keypad 404. In one mode, the numeral two, four, six and eight buttons can be used to move the camera up, left, right and down, respectively.

The keypad 404 can include a light source that blinks to indicate that the keypad is being used in an alternate mode. The user control unit 400 can also include a user interface (UI) button 426 which can display a user interface to a designated output device 110. Pressing the UI button 426 a second time will return the designated output device to display whichever input was shown prior to displaying the user interface screen.

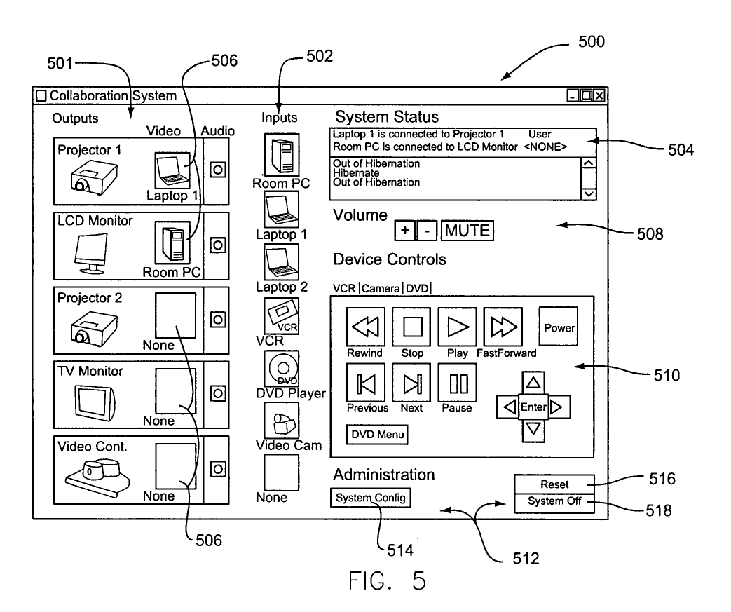

FIG. 5 is a screen shot of an example user interface 500 that can be viewed on a display device such as a monitor 122, the plasma television 124, a liquid crystal display (LCD) and/or a projector screen 128. The projection screen 128 can be movable to suit a user's needs. The user interface 500 can be displayed on a standalone display device such as monitor 122 or on a user display device such as on the laptop 134, a tablet PC and/or a PDA. The user interface 500 can be displayed by pressing the UI button 426 of the keypad 404 (FIG. 4). The user can interact with the user interface 500 with a device such as a mouse, a light pen, a touch sensitive screen and a microphone for voice activated applications. The user can point to, click and drag objects displayed on the user interface 500.

Outputs 110 are represented by output objects 501, such as icons. Inputs 108 are also represented by input objects 502. A system status object 504 can be used to display a status of the control system 100. The objects displayed by the user interface 500 can include pull down menus to present the user with options and/or additional objects such as icons. In addition, the objects 502 representing the inputs 108 can be dragged into and out of a source icon field 506 of the output object 501 of the outputs 110. In this way, a user can alternatively designate which inputs 108 connect with which outputs 110. Users can disconnect an input device 108 from an output device 110 by either dragging the none input object 502 into the output object 501 or dragging the selected input object 506 out of the output object 501.

In addition to the system status object 504, the user interface 500 can include controls, such as volume controls 508, device controls 510 and administration buttons 512. The system status object 504 displays which equipment is connected to the control system 100 and the status of the equipment, such as on, off and hibernation. The volume controls 508 can be used to adjust the volume of the audio level of sound equipment in the control system 100. The device controls 510 can be tailored to the specific equipment being controlled to include more or less buttons than those shown. The DVD controls can include rewind, stop, play, fast forward, pause, next and previous, DVD menu, directional navigation keys and power. VCR controls may include rewind, stop, play, fast forward, pause and power. Video camera control can include buttons to control pan, tilt and zoom. The video camera can be controlled directly and by using preset position settings stored in memory. A take picture button can also be included to obtain a picture of the current position of the video camera. The picture can be saved and/or sent to others, such as by using electronic mail or a storage medium.

The administration buttons 512 can include a system configuration button 514, a reset button 516 and a system off button 518. The system configuration button 514 can display other screens with information about the control system 100 such as user settings and a version of the software. Access to the control settings can be limited such that only administrators can change these settings on the configuration screens. The reset button 516 can reset software of the control system 100 to original startup settings. The system off button 518 can set the control system 100 in an off or hibernation state depending on administration settings. The control system 100 can be reactivated by pushing any other button on the user interface 500 or the user control unit 400.

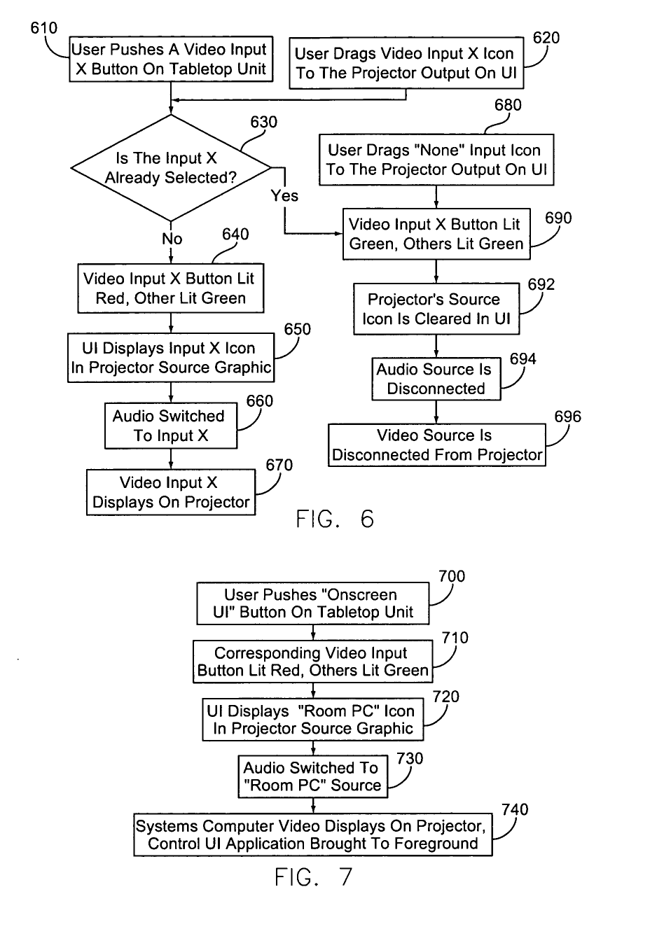

FIGS. 6-15 address some of the ways in which the control system 100 can be used. FIG. 6 is a flowchart illustrating a user control of operation of the inputs devices 108. At block 610, to control a specified piece of equipment a user pushes an input device button 406 (FIG. 4) such as a button on the user control unit 400 corresponding to a DVD player. In addition, at block 620 the user can drag a video input icon of the user interface 500 (FIG. 5) to an output object 501, such as a projector. In addition, the equipment can be controlled automatically, for example, at a specified time. At block 630, the control system 100 determines whether the input device 108 is already selected. At block 640, if the input device 108 was not already selected, the input device 108 is switched, such as with switch 230, into an active mode.

The active mode can be represented to the user by lighting the device button 406 that corresponds to the input device 108. For example, a red light can indicate that the input device 108 has been activated and a green light can indicate that the input device 108 has been deactivated, or vice versa. At block 650, the user interface 500 can display the icon representing the input device positioned in the output object 501. For example, an icon representing the DVD player can be displayed in the object representing the projector. At block 660, the control system 100 switches an output device 110, such as an audio output device, to connect with the input device 108. At block 670, output coming from the input device 108 is displayed on the selected output device 110, e.g., the projector.

At block 680, if the user drags a “none” input icon to an output object 501 or if the input device is already selected on the user control unit 400, the input device 108 is deactivated. At block 690, the device button 406 can be lit, e.g., to a certain color that indicates the deactivation, or a light can be turned off. At block 692, the source icon field 506 is cleared on the user interface 500. At block 694, a corresponding audio source can be disconnected from the input device 108, for example, with a switch. At block 696, the input device 108 can be disconnected from the projector or other display device.

FIG. 7 is a flowchart illustrating a user activating a control user interface. The control user interface can display the states of the devices controlled by the processor 104. Rather than only controlling a single device, several devices are configured at the touch of a single button. The control user interface can remove a great deal of complexity and debugging that users repeatedly perform with other direct control based equipment setups. At block 700, the user presses the UI button 426 on the user control unit 400 or another unit (FIG. 4). At block 710, an input device button 406 corresponding to a control input device is lit to indicate activation. At block 720, the user interface 500 displays the control input device, such as a PC, in the displaying output device 110, such as a projector. At block 730, the control input device is connected to an audio output, such as a speaker. At block 740, the interface for the control system 100 is displayed to the user, for example on a monitor or a screen for a projector.

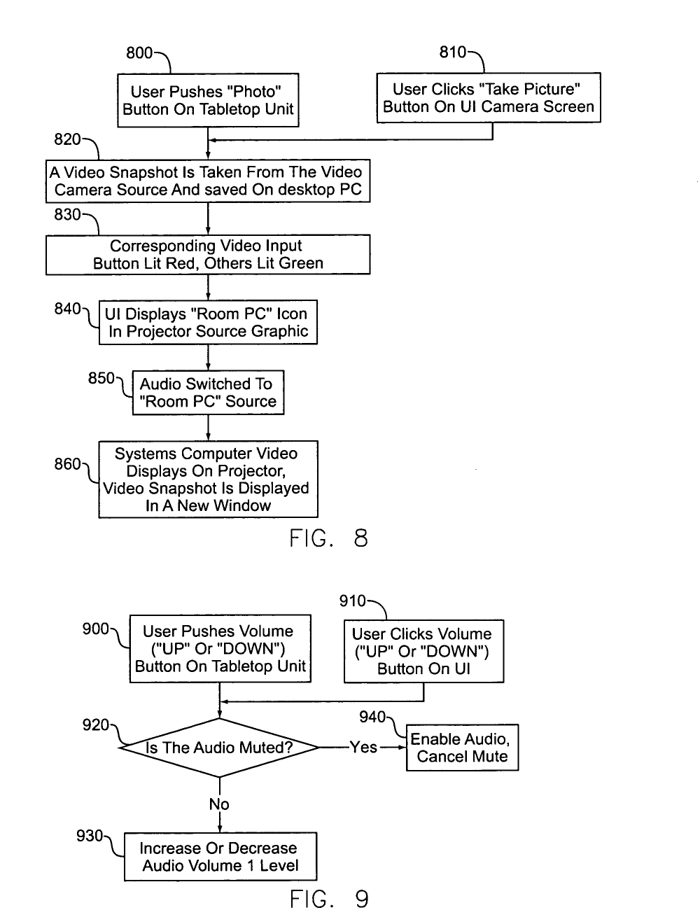

FIG. 8 is a flowchart illustrating a user using the control system 100 to obtain a snapshot or video. At block 800, the user pushes the photo button 422 of the user control unit 400 or at block 810 picks a take photo button of the user interface 500. At block 820, a snapshot or screen shot is obtained such as from a video camera. The snapshot can be saved in memory. In addition, a video stream can be obtained from the video camera and saved into memory. Thereafter, at block 830, a user PC can automatically be connected to a display device and a corresponding button representing the user PC can be lit to indicate the activation. At block 840, the user interface 500 can be updated to indicate that the user PC is connected with the projector device or a monitor. At block 850, an audio output source such as speakers can be connected to the PC. At block 860, the snapshot can be displayed by the projector, such as in a new window. All of these actions can be automatically performed by the control system 100, without any other user interaction required, upon the user pressing the photo button.

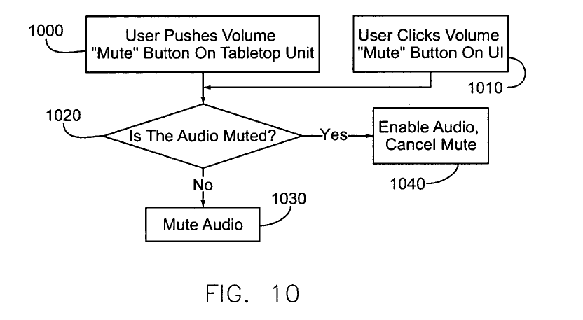

FIG. 9 is a flowchart illustrating user control of the volume of audio systems of the control system 100. At block 900, to change the volume of audio outputs connected to the control system 100, the user can push the up volume button 414 or the down volume button 416 located on the user control unit 400 and/or at block 910 by engaging the volume buttons 508 located on the user interface 500. The volume can also be controlled in other ways such as with other input devices 108, such as via a telephone, connected with the control system 100. At block 920, the control system 100 determines whether the audio output is muted. At block 930, if the audio output is not muted, the control system 100 changes the volume level by a determined amount, such as by one unit level. At block 940, if the audio output is muted, mute is cancelled and the audio output is enabled.

FIG. 10 is a flowchart illustrating user control of the mute of audio systems of the control system 100. At block 1000, the user pushes the mute button 418 on a device such as the user control unit 400, and/or at block 1010 the user engages the mute button on the user interface 500. The control system 100 determines if the audio output was muted before the button was pushed. At block 1030, if the audio output was not muted, the control system 100 mutes the audio output. At block 1040, if the audio output was muted, the control system 100 cancels the mute function and enables the audio output.

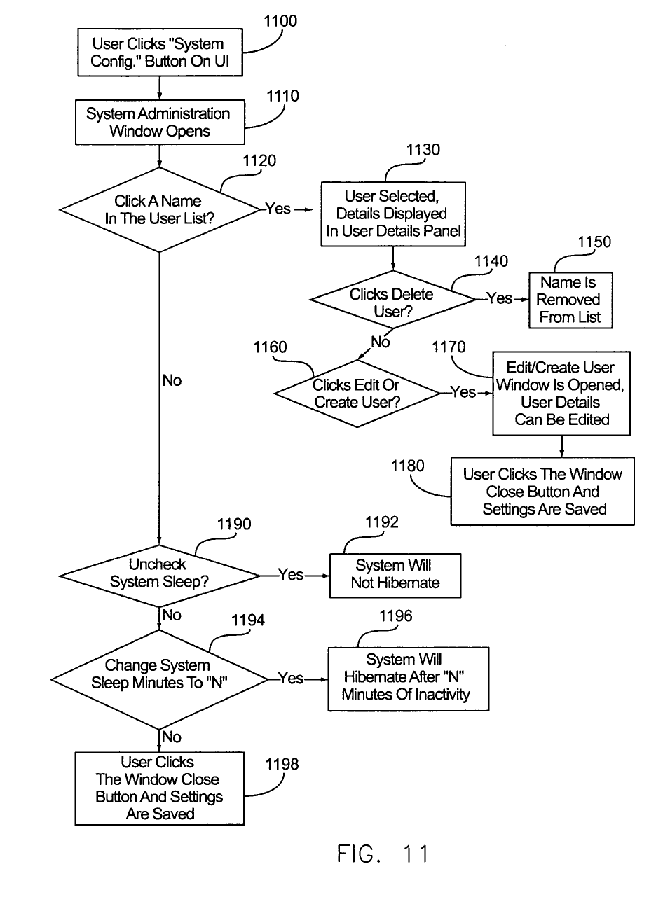

FIG. 11 is a flowchart illustrating a user, such as a system administrator, accessing system configuration information of the control system 100. At block 1100, the user can engage the system configuration button 514 of the user interface 500 to obtain system configuration information. At block 1110, a system administration window can be displayed on a display device. At block 1120, the control system 100 determines whether a name in a user list has been selected. At block 1130, if a user has been selected, details about the selected user, such as a user name, a home file directory path on file servers and an ID tag, are displayed in a user details panel, such as a window. Other User detail files can be added as needed. The administrator can add or delete names from the list, such as the names of those that can operate the control system 100. The system can be protected so that only registered users can control the system or more open access is also possible. At block 1140, the control system 100 determines whether the user has determined to delete the selected user. At block 1150, the selected user is removed from the list if the user has been selected to be deleted. At block 1160, if the user has not been selected to be removed from the list, the control system 100 determines whether the user has been selected to edit information about the user or the option has been created to create a new user. At block 1170, if the user desires to edit or create a user profile, a window can be opened to accommodate the editing and/or the creation. At block 1180, the information can be saved in memory, such as a memory of the control system 100, and the window can be closed.

At block 1190, the control system 100 determines whether the user desires to deactivate a system low power option during non-use. At block 1192, if the user selects to deactivate the low power option, the control system 100 will not hibernate. At block 1194, the control system 100 determines if the user has selected to change the time period until the control system 100 powers down to a low power mode. At block 1196, the user can select the time, such as in minutes, which elapse before the control system 100 powers down to the low power. At block 1198, when the user closes the system administration window the updated settings can be saved.

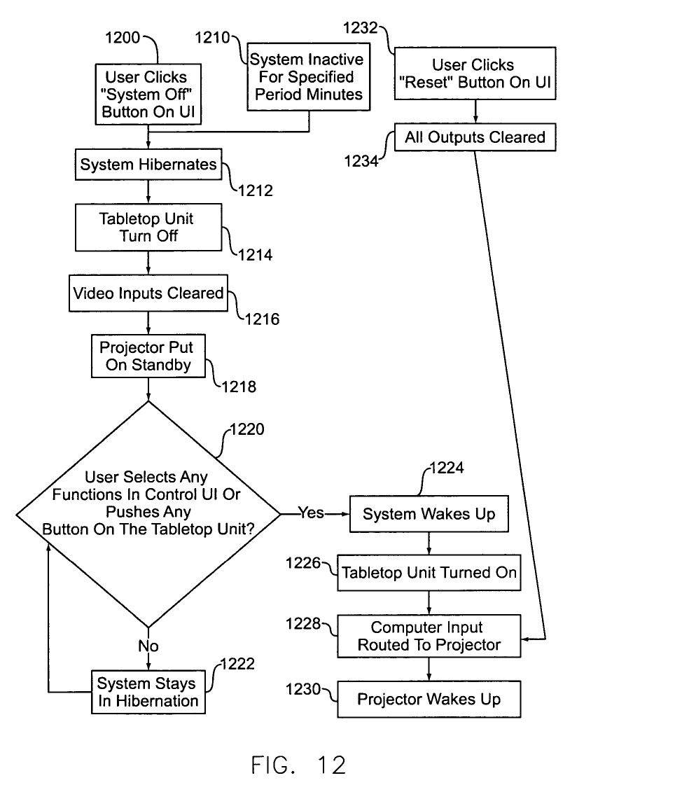

FIG. 12 is a flowchart illustrating power down functions of the control system 100. At block 1200, the user engages the system off button 518 of the user interface 500, or at block 1210 the control system 100 is inactive for a determined period of time. At block 1212 the control system 100 enters a low power state, such as hibernation. At block 1214, the control system 100 can turn off the user control unit 400. At block 1216, the control system 100 can clear the input devices 108. At block 1218, the control system 100 can place the output devices 110, such as projectors, on standby. At block 1220, the control system 100 determines whether the user has selected any functions in the user interface 500 or whether any of the buttons 404, 406 or the reader 412 have been used. At block 1222, the control system 100 remains in hibernation until the user selects a function. At block 1224, if the user accesses the control system 100, the system is powered on. At block 1226, the user control unit 400 is powered. At block 1228, the processor 104 of the control system 100 is connected with an output device 110 such as a projector. At block 1230, the output device 110 is powered. At block 1232, if the user engages the reset button 516 of the user interface 500, at block 1234 all output devices 110 are reset. Thereafter, at block 1228, the control system 100 automatically connects the processor 104 to the output devices 110 and at block 1230, the projector is powered on.

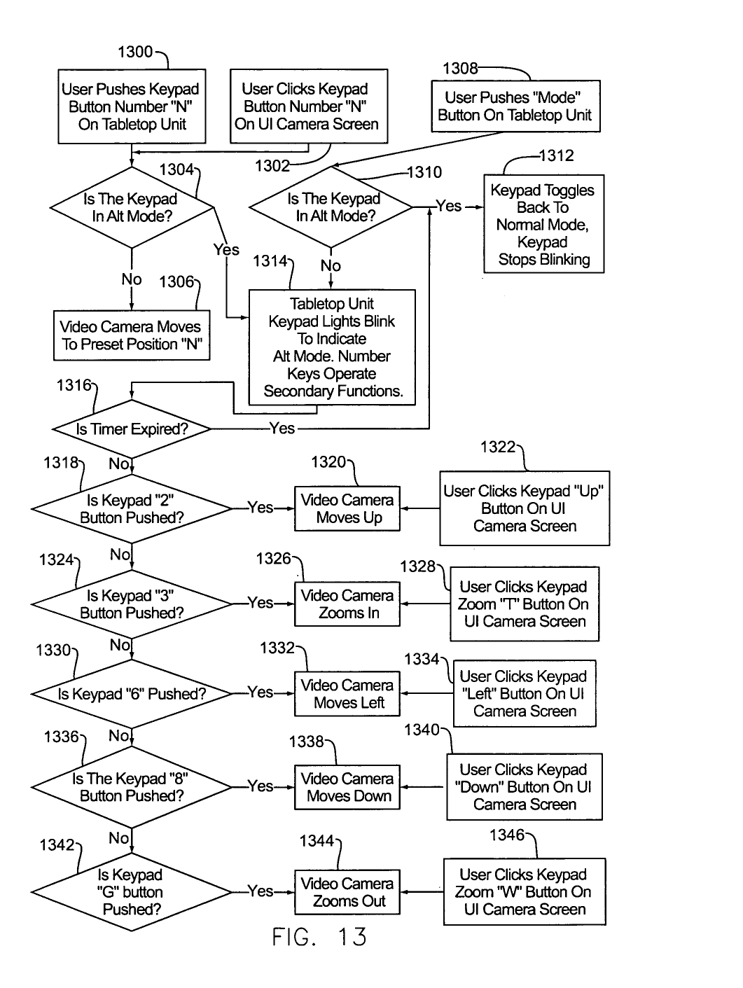

FIG. 13 is a flowchart illustrating a use of the video camera settings of the control system 100. At block 1300, the user can engage a keypad button 404 of the user control unit 400, and/or at block 1302 the user can engage keypad buttons displayed on the user interface 500. At block 1304, the system controller 100 determines whether the keypad is operating in an alternate mode. At block 1306, if the keypad is not operating in the alternate mode, the camera 134, 208 moves to the preset position corresponding to the number engaged. At block 1308, to switch between the alternate mode of the keypad and the standard mode, the user can engage the mode button 424 located on the user control unit 400 or another device such as the user interface 500. At block, 1310, when the mode button 424 is engaged, the control system 100 determines whether the keypad 404 is operating in the alternate mode. At block 1312, if the keypad 404 was operating in the alternate mode before the mode button 424 was engaged, the keypad 404 switches to operate in the standard mode. The control system 100 may supply a visual indication the current mode of operation such as by blinking the keypad 404 when operating in the alternate mode, or vice versa.

At block 1314, if the keypad was not operating in the alternate mode before the mode button 424 was engaged, the mode is changed to the alternate mode. At block 1316, to automatically reset the mode to the standard mode, the control system 100 determines if a time period has expired. At block 1312, if the time period has expired, the mode is changed to the standard mode. Alternatively, the mode may remain the same until changed by a user.

The keypad 404 of the user control unit 400 and/or the user interface 500 can be used to control movement of the input device 108 such as a camera. At block 1318, the control system 100 determines if the two key was engaged by the user in the alternate mode. At block 1320, if the two key was engaged the camera moves up. At block 1322, the user can also command the camera to move up by engaging a button on the user interface 500. At block 1324, the control system 100 determines if a three key was engaged by the user in the alternate mode. At block 1326, if a three key was engaged the camera zooms in. At block 1328, the user can also command the camera to zoom in by engaging a button on the user interface 500. At block 1330, the control system 100 determines if a six key was engaged by the user in the alternate mode. At block 1332, if a six key was engaged the camera moves left. At block 1334, the user can also command the camera to move left by engaging a button on the user interface 500. At block 1336, the control system 100 determines if an eight key was engaged by the user in the alternate mode. At block 1338, if an eight key was engaged the camera moves down. At block 1340, the user can also command the camera to move down by engaging a button on the user interface 500. At block 1342, the control system 100 determines if a nine key was engaged by the user in the alternate mode. At block 1344, if a nine key was engaged the camera zooms out. At block 1346, the user can also command the camera to zoom out by engaging a button on the user interface 500.

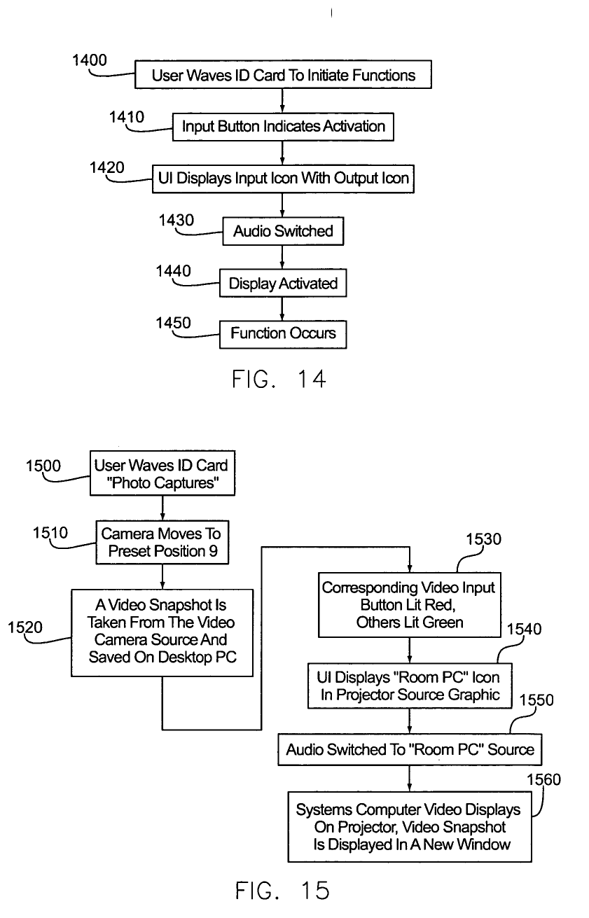

FIG. 14 is a flowchart illustrating a use of the ID card to perform functions with the control system 100. At block 1400, the user positions the ID card near the reader 412 (FIG. 4) to perform a specified function such as playing a DVD, playing a video tape, opening a file and opening a website. At block 1410, the control system 100 can light a button that corresponds to the input device 108 being used to provide a visual indication to the user of the input device 108 being used. For example, the button corresponding to the input device 108 being used can be light red and the remaining buttons can be lit green, or vice versa. Other colors or an on/off state of the lights could be used. At block 1420, the control system 100 updates the user interface 500 to display icon representing the input device 108 with the icon representing the output device 110, such as a projector, being used. At block 1430, audio is connected with the input device 108. At block 1440, signals from the input device 108 are displayed by the output device 110, such as a projector or a printer. At block 1450, the function is performed, such as the DVD being played, the video tape being played, the file associate with the card being opened and/or the website associated with the card being opened. The website can be opened in one or more web browser windows of one or more PCs. The card can also store the preset positions of a room, such as camera positions and connections between the various input devices 108 and output devices 110. When the card is read by the reader 412, the control system 100 can automatically configure the room to the preset positions.

FIG. 15 is a flowchart illustrating a use of the ID card to perform an image capture function with the control system 100. At block 1500, the user positions the ID card, such as an RFID card near the reader 412. At block 1510, the camera moves to a preset position to point at a determined object, such as a projector screen and a whiteboard. At block 1520, a snapshot or a video stream is performed. The snapshot or video stream can be saved to memory and/or sent to another person. At block 1530, a button is lit on the user control unit 400 that corresponds to an input device 108 such as a PC. At block 1540, the user interface 500 shows that the PC is connected to a display such as a projector. At block 1550, an audio device is connected to the input device 108. At block 1560, the snapshot or video stream is displayed to the user, such as in a new window of the display.

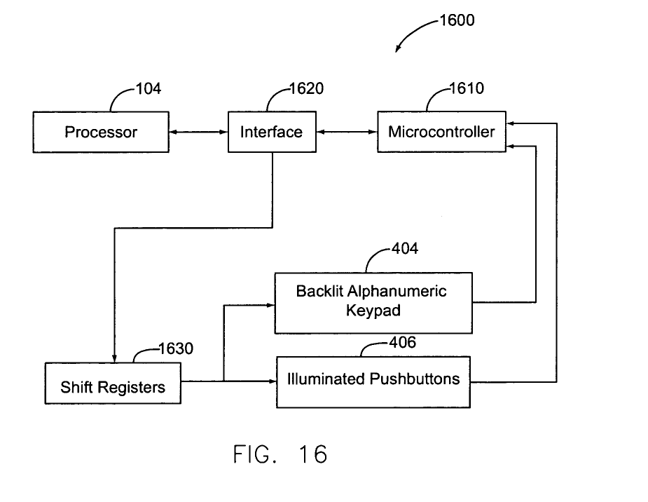

FIG. 16 is a block diagram illustrating control hardware 1600 to perform the functions offered by the user control unit 400. The hardware 1600 includes a microcontroller 1610 that can run firmware and/or software. The microcontroller 1610 communicates with the processor 104, such as a PC, through an interface 1620, such as an RS-232 serial interface. The processor 104 and microcontroller 1610 exchange messages defined by a protocol that, for example, allows the microcontroller 1610 to notify the processor 104, and software applications running on the processor 104, when an event occurs, such as pressing a buttons 404, 406 or engaging the reader 412.

The protocol also allows the processor 104 to modify the illumination state of buttons 404, 406, such as with light emitting diodes (LED). The protocol can include any number of digital or analog communication protocols. In one instance, the protocol is a two-way RS-232 serial connection using a predefined set of ASCII command and response codes. In accordance with signals from the processor 104, the microcontroller 1610 writes data to a set of shift registers 1630 that hold the state of the LEDs that illuminate the keypad 404 and pushbuttons 406. The shift registers 1630 can also provide the necessary power to drive the LEDs. The microcontroller 1610 monitors the state of the keypad 404 and pushbuttons 406 and responds when a key or button is pressed. The microcontroller 1610 responds by sending an ASCII message indicating the key that has been pressed. The processor 104 can continuously or periodically observe the device's communication port for such messages and reports the messages to the control program to change system state.

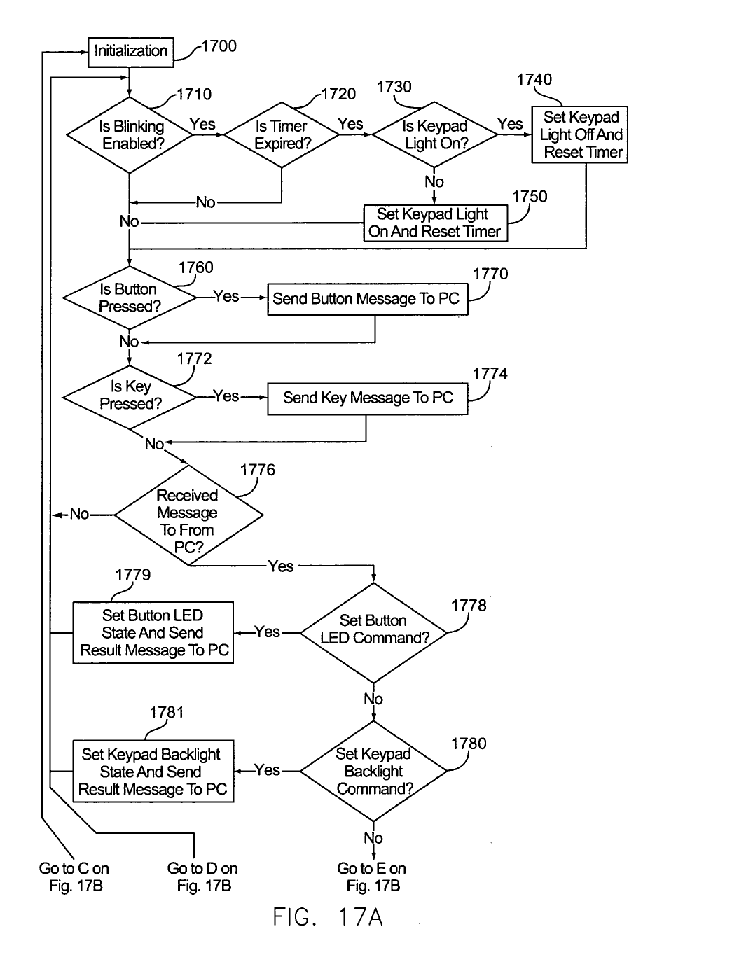

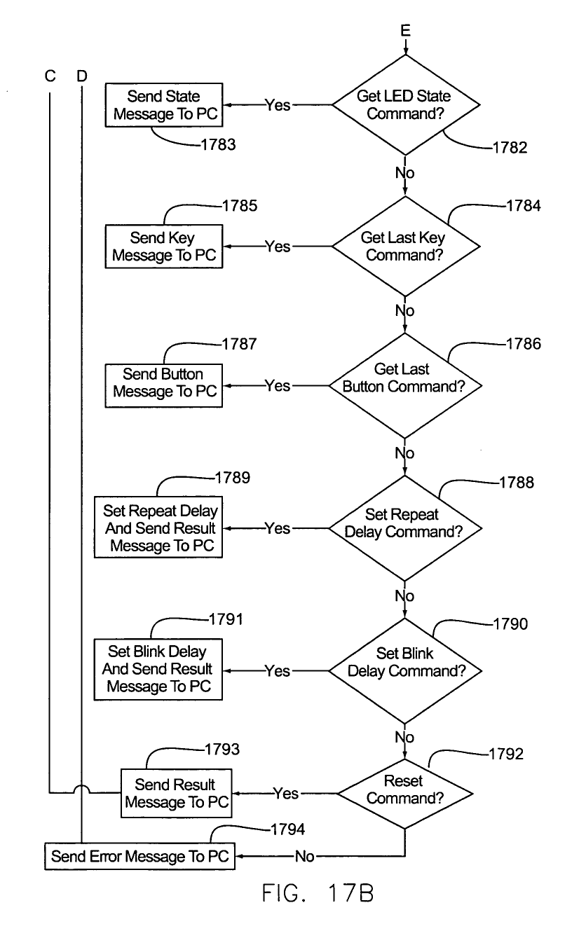

FIGS. 17A and 17B is a flowchart illustrating an operation of exemplary firmware run by the microcontroller 1610. At block 1700, execution of the firmware begins upon initialization. A task of the firmware is to change the illumination state of a backlight of the keypad 404, and, if necessary, to produce a blinking effect. The keypad backlight can be in an off, on, or blinking state. At block 1710, the state is determined of the backlight of the keypad 404. At block 1720, if the backlight is blinking, a determination is made whether a determined time period has elapsed. At block 1730, if the determined time period has elapsed, a determination is made whether a light of the backlight is on. At block 1740, if a light of the backlight is on, the light is turned off and the elapsed time period is reset. At block 1750, if the light is not on, the light is turned on and the elapsed time period is reset.

At block 1760, a next task determines if one of the pushbuttons 406 is pressed. At block 1770, if one of the pushbuttons 406 is pressed, the microcontroller 1610 sends an event message to the processor 104.

At block 1772, a next task is to determine if one of the keys in the keypad 404 is pressed. At block 1774, if one of the keys in the keypad 404 is pressed, an event message is sent to the processor 104.

At block 1776, a next task is to determine if a command message has been received from the processor 104. If not, execution of the firmware branches to the start of the main service loop at block 1700 and the set is repeated of the tasks. Otherwise the command message is interpreted.

At block 1778, a determination is made whether a command was received from the processor 104 to set the pushbutton LED state. At block 1779, if so, the LED state is set and a result message is sent to the processor 104. At block 1780, a determination is made whether a command was received to set the keypad backlight state. At block 1781, if so, the keypad backlight state is set and a result message is sent to the processor 104. At block 1782, a determination is made whether a command was received to retrieve the overall state of the LED's, e.g., both the pushbuttons 406 and the backlights of the keypad 404. At block 1783, if so, a state message is sent to the processor 104. At block 1784, a determination is made whether a command was received to retrieve the last key pressed. At block 1785, if so, a key message is sent to the processor 104. At block 1786, a determination is made whether a command was received to retrieve the last button pressed. At block 1787, if so, a button message is sent to the processor 104. At block 1788, a determination is made whether a command was received to set the repeat delay between event messages when a button or key is pressed and held down. At block 1789, if so, a repeat delay is set and a result message sent to the processor 104. At block 1790, a determination is made whether a command was received to set the flashing frequency of the keypad backlight blinking. At block 1791, if so, a blink delay is set and a result message sent to the processor 104. At block 1792, a determination is made whether a command was received to reset the user control unit 400 which causes the initialization procedure to be executed. At block 1793, if so, a result message sent to the processor 104. At block 1794, if the command is not recognized or if the command message contains an error, the user control unit 400 responds with an error message.

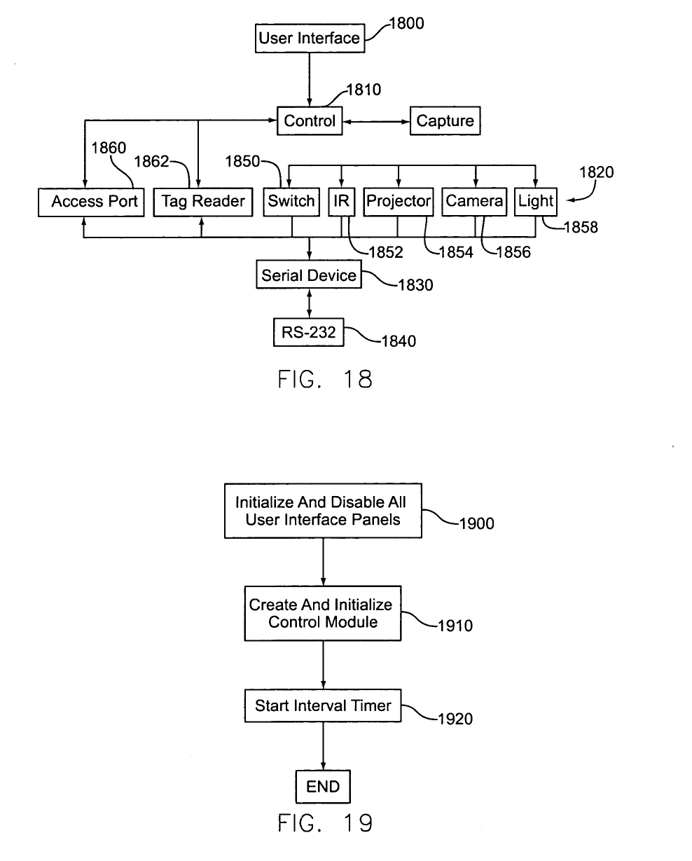

FIG. 18 is a block diagram illustrating a software architecture of the control system 100. The software can be executed by the processor 104. The software can control of a wide array of equipment through a single processor-based control system 100. The central activity of the system is directing multiple video and RGB input devices 108, such as VCRs, laptops and cameras, to multiple outputs devices 110, such as projectors, computer monitors and video monitors.

The architecture includes a multi-threaded, object-oriented system of intercommunicating components. The user interface 500 drives the behavior of the program. When user interface actions are invoked, the actions invoke a callback function in an interface module 1800, which invokes a set command in a control module 1810. The user interface 500 is the graphical representation of the interface module 1800. The interface module 1800 is the software module that implements the user interface 500. Part of the software creates the graphical interface 500, and other parts of the software produce the behavior of the user interface 500. Communication to the control 1810 is generalized and simplified, by allowing the invocation of a set command and then two optional arguments, e.g., one textual and the other numeric.

The control module 1810 communicates with devices, such as user equipment 1820, connected through multiple ports, such as serial ports 1830. The equipment 1820 is represented as a software class which inherits from a generic serial device object. The serial device 1890 uses a variety of functions from a lower-level communication library 1840, such as RS-232. The serial device 1890 initializes serial ports and automatically detects the port that the equipment 1820 is attached to. Some of the equipment only utilizes one-way, synchronous communication from the processor 104 to the device, invoked such as switch 1850, IR 1852, projector 1854, camera 1856 and light 1858. Other devices include both synchronous and asynchronous invocation such as access port 1860 and tag reader 1862. Asynchronous invocations include the notification of the control module 1810 of an access port 1860 keypress.

The access port 1860 is the software module that allows communication with a hardware device such as the user control unit 400 that allows control of most equipment in the control system 100. Actions such as lighting up buttons are synchronously invoked, while actions such as key presses are asynchronously invoked. For example, the pressing of a button of the keypad 404 can first be read through an asynchronous thread in the RS-232 package and then communicated to the serial device class through a callback. Thereafter, the button press is brought up to the specific device class, which in turn produces an event that the control system 100 responds to and queues to be handled on the next timer tick. The capture class is invoked when the capture command is initiated through the control unit 400, or user interface 500. The class reads the analog video attached to a video capture device on the processor 104 and uses lower level software libraries to convert this image from analog to digital and store it in memory or on a file on the processor 104.

FIG. 19 is a flowchart illustrating the beginning of execution of the control system 100. At block 1900, user interface panels are disabled to the user. At block 1910, control module 1810 is created and initialized. At block 1920, an interval timer is started, which interrupts at determined time intervals, such as 50 ms intervals. Activities handled during timer callbacks include the processing necessary to handle requests from the hardware devices such as those attached to the access port 1860 and the tag reader 1862. Other activities performed at timer callbacks include maintaining other necessary state information and keeping the user interface 1800 in synchronization with the state of the control system 100.

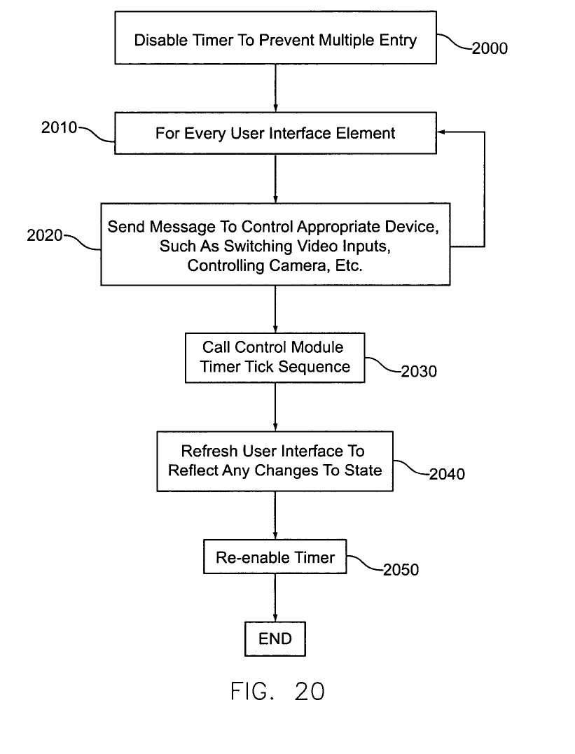

FIG. 20 is a flowchart illustrating tasks performed at each timer interval. At block 2000, the timer is disabled to prevent multiple simultaneous calls of this function. At block 2010, for the sake of simplifying the actions of the user interface 500, the processing of every user interface 1800 element is shown. At block 2020, interface actions are translated into calls to the control module 1810 to invoke the appropriate changes to the hardware devices, such as switching video inputs. The functions are invoked through callbacks. At block 2030, the timer tick sequence for the control module 1810 is called. At block 2040, the user interface 1800 is updated to reflect any changes to state such as volume level and source routing. At block 2050, the timer is re-enabled before exiting.

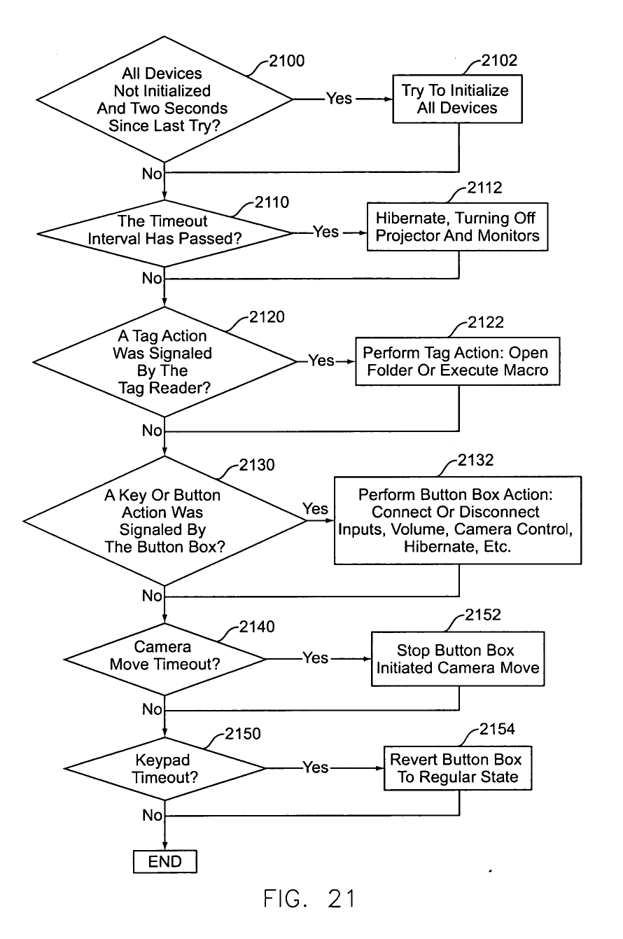

FIG. 21 is a flow chart illustrating a control module 1810 timer tick sequence. At blocks 2100 and 2102, the timer callback of the control module 1810 first attempts to initialize all of the devices 1820 if they are not yet initialized and a time period, such as two seconds, has elapsed since the last try. At blocks 2110, the control module 1810 determines if no activity has occurred in the interface or hardware for a time exceeding the timeout period. If so, at block 2112 the control module 1810 turns off the output devices 110 such as the projectors and monitors, and clears all outputs, to enter hibernation. A key being pressed will wake the system from hibernation. At block 2130, the system checks for queued messages to handle a tag read request. If there is one, at block 2122 an application such as a macro is invoked or a user folder is opened by checking the stored mapping from tag to user or macro. At block 2130, the control module 1810 determines if a key or button event has been queued for the access port 1860. If so, at block 2132 an appropriate action is taken, such as moving the camera or switching an input. At blocks 2140 and 2150, timeouts are handled for key presses and camera modal actions. At blocks 2152 and 2154, if a timeout has been exceeded without input, the system reverts to its normal state from the previous mode, such as camera-movement mode through the keypad.

The control system 100 can be fault-tolerant with regard to networking, protocol and hardware failures. The software architecture can repeatedly verify which input devices 108 and output devices 110 are connected with the processor 104. The software architecture can also initialize any un-initialized input devices 108 and output devices 110, such as devices newly added to the control system 100. As input devices 108 and output devices 110 become available or become disabled, e.g., due to device, connector or protocol problems, the individual user interface component, e.g. a projector represented by and object 501, is enabled or disabled. Also, underlying device software components, e.g. projector 1854, are enabled or disabled. The remainder of the control system 100 can continue to function without interruption.

The automatic periodic or continuous initialization and monitoring of input devices 108 and output devices 110 allows for the recognition of components switched into and out of the control system 100 without having to reset the control system 100. Individual devices such as the projector, the video camera, and the tag reader, can be added and removed from the system while the system is running. When a component is removed, the control module recognizes the removal and disables that component. When a component is added, the control module recognizes the component and re-enables the added component. The port or protocol can also be switched that the device or component is connected through. For example, the projector could be disconnected from serial port 1 and re-connected through serial port 12. This might be necessary if ports are located in physically disparate places, such as placing connectors over various parts of a conference room and/or in remote locations. Additionally, if a device supports multiple protocols, the device can be disconnected from one protocol, e.g. disconnect the projector from serial port 1, and then re-connect the device through another protocol, e.g. connect the projector to USB port 2. This assumes that the individual device supports communication through multiple protocols.

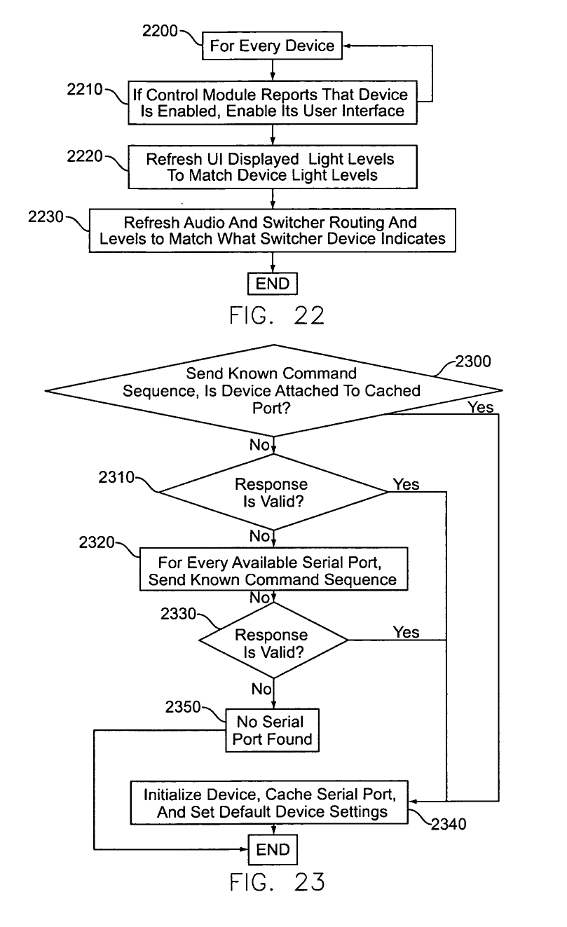

FIG. 22 is a flowchart illustrating a control system 100 refresh user interface sequence. The sequence for refreshing the user interface 1800 can be called at each timer tick at the user interface level. At blocks 2200 and 2210, the function checks with the control module 1810 to determine if each device is enabled. If so, the user interfacel 800 enables the controls for that device. For example, when the router switch is enabled, all of the input and output drag-and-drop boxes are enabled. At block 2220, a user interface light level indicator is set to reflect the current light level. At block 2230, the audio levels and video routing are similarly updated, so that all of the on-screen user interface objects match the state of the system being controlled.

FIG. 23 illustrates an initialize device sequence that can be executed for each device 1820 in the sequence. The sequence can be implemented in the serial device module 1830, but invoked in each device module in a device-dependent manner. At block 2300, each class of devices 1820 writes a method called “IsPortDevice” which determines if the given device is attached to the given port by sending a device-dependent command. The function begins by sending the sequence to the port that the device 1820 was last attached to. At block 2340, initialization can occur very fast when nothing has changed in the hardware connections. At block 2310, if that was unsuccessful, at block 2320 the function steps through available serial ports or other communication ports and sends the query sequence. At block 2330, when the correct serial port is found, at block 2340 the port is cached and the device is initialized and ready for use. If not, at block 2350, the function fails and returns. The control system 100 can function with any number of devices functioning and will continue to find the devices as long as the program is running. Devices can be connected through other types of ports, such as Ethernet, infrared, wireless, parallel ports, USB and Firewire (IEEE 1394).

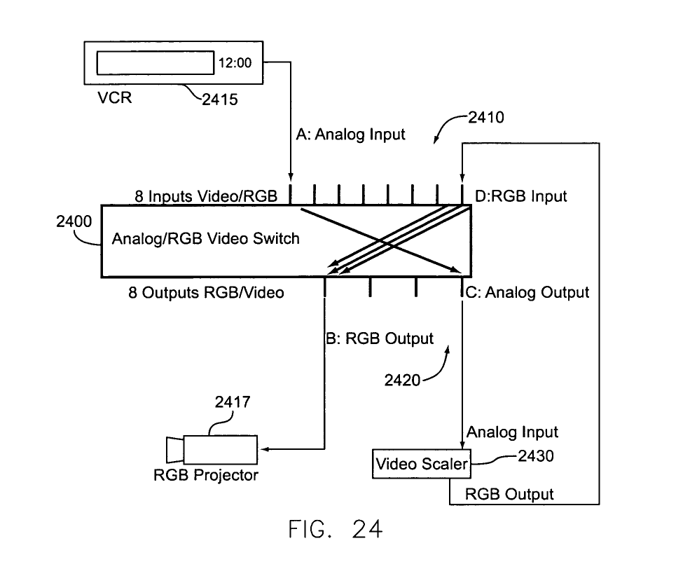

FIG. 24 is a block diagram illustrating exemplary wiring to an input/output analog/video switch. A video switch 2400 can include inputs 2410 and outputs 2420. The inputs 2410 to the video switch 2400 can be analog video (video) or RGB video (computer). The video inputs include camera, VCR 2415 and DVD 132. The video outputs include a projector 2417. An output 2420 can be connected to a video scaler device 2430 which converts analog video to RGB video. An output of the video scaler device 2430 connects into one of the inputs 2410 to a router as RGB video.

When a user chooses to route a signal from a video device to an RGB output, the video signal input is routed to the video scaler input in the switch. An output of the switch is connected with a determined switch input. That switch input is then routed to the desired RGB output. For example, A is video input 2415, B is chosen RGB output 2417, C is video scaler input (video->RGB converter, video in), D is the video scaler output (RGB out), and D is the switch input into which the output of the video scaler loops back. To route the video signal A to the RGB output B, A is routed to C and D is routed to B. Thereafter the user can view video output from the video device on the output.

It is to be understood that changes and modifications to the embodiments described above will be apparent to those skilled in the art, and are contemplated. It is therefore intended that the foregoing detailed description be regarded as illustrative rather than limiting, and that it be understood that it is the following claims, including all equivalents, that are intended to define the spirit and scope of this invention.

1. A system for controlling multiple input devices and at least one output device in a video presentation system comprising:
a user control interface;
a processor connected to the user control interface, the multiple input devices and the at least one output device, wherein the processor is operable through the user control interface to select one of the input devices, determine the operating state of the selected input device, control an operating state of the selected input device, and determine and control the operating state of the at least one output device in accordance with the determined operating state of the input devices and the at least one output device.

2. The system of claim 1, wherein the processor is connected to multiple output devices and wherein the processor is operable to select one of the output devices and control an operating state of the output devices.

3. The system of claim 1, wherein the multiple input devices are selected to include at least two devices selected from the group consisting of a personal computer, a video cassette player, a DVD player, a videoconferencing device, and a video camera.

4. The system of claim 1 wherein the multiple input devices include video inputs from at least two personal computers.

5. The system of claim 4 wherein at least one of the personal computers is connected to a network.

6. The system of claim 5 wherein the network includes the Internet.

7. The system of claim 2, wherein the multiple output devices are selected to include at least two devices selected from the group consisting of an LCD projector, a CRT monitor, a plasma screen, and a videoconferencing device.

8. The system of claim 1 wherein the user control interface comprises a graphical user interface, wherein each of the multiple input devices is represented by an icon.

9. The system of claim 8 wherein an input device is selected by moving the icon to a labeled location.

10. The system of claim 8 wherein the graphical user interface further comprises control icons for controlling each of the multiple input devices.

11. The system of claim 10 wherein the type and arrangement of control icons on the graphical user interface varies depending on which of the multiple input devices is selected.

12. The system of claim 1 wherein the user control interface includes a reader device.

13. The system of claim 12 wherein the reader device is operable to read a card.

14. The system of claim 13 wherein the card comprises a card that emits a radio frequency signal.

15. The system of claim 13 wherein the card opens at least one of a specified web page and a file.

16. The system of claim 13 wherein the card controls the operating state of the input device and the output device.

17. The system of claim 13 wherein the card stores user preferences.

18. The system of claim 17 wherein the user preferences include setup preferences for the input devices and the output devices.

19. The system of claim 13 wherein the card allows a user to access the user control interface.

20. The system of claim 20 wherein the card activates a camera to obtain a snapshot.

21. The system of claim 1 wherein the processor is further connected to multiple audio input devices and at least one audio output device, and wherein, through the user control interface, the processor is operable to select one of the audio input devices and determine and control an operating state.

22. The system of claim 21 wherein the multiple audio input devices are selected to include at least two of audio input devices selected from the group consisting of a microphone, a telephone, an audio output from a personal computer, an audio output of a video cassette player, an audio output of a DVD player, and the audio output of a videoconferencing system.

23. The system of claim 1 wherein the processor is further connected to room lighting and wherein, through the user control interface, the processor is operable to control the room lighting to enhance video display and presentation.

24. The system of claim 1 wherein the processor is further connected to moveable screening and wherein, through the user control interface, the processor is operable to control the moveable screening to enhance video display and collaboration.

25. The system of claim 1 wherein the user control interface comprises a video panel.

26. The system of claim 25 wherein the video panel accommodates touch screen inputting.

27. The system of claim 1 further including at least one sensor connected with the processor.

28. The system of claim 27 wherein signals from the at least one sensor are considered by the processor when controlling the selected input device and the at least one output device.

29. The system of claim 1, further including a video scalar connected with the processor.

30. The system of claim 29, wherein the processor automatically routes video from the selected input device through the video scaler only when required for video format compatibility with the at least one output device.

31. A control system to control video, comprising:
a user control interface including a processor, wherein the processor is operable to determine an operating state of at least two input devices and at least one output device and further operable to change an operating state of the at least two input devices and the at least one output device in accordance with a command from the user control interface.

32. The system of claim 31 wherein the user control interface comprises a hardware controller.

33. The system of claim 32 wherein the hardware controller includes buttons that correspond to the at least two input devices.

34. The system of claim 33 wherein the buttons include an indicator that allows a user to determine which input device is being connected to an output device.

35. The system of claim 32 wherein the hardware controller further comprises firmware.

36. The system of claim 31 wherein the user control interface includes a reader.

37. The system of claim 36 wherein the reader is operable to read a card.

38. The system of claim 37 wherein the card comprises a card that emits a radio frequency signal.

39. The system of claim 38 wherein the card at least one of activates a specified web page and opens a program file.

40. The system of claim 38 wherein the card controls a function of a determined input device and a determined output device.

41. The system of claim 38 wherein the card includes clear indicia denoting its function.

42. The system of claim 38 wherein the system is activated only upon the reading of an authorized card.

43. The system of claim 42 wherein the system stores preferences for users of the system as identified by the card.

44. The system of claim 38 wherein a user is granted access to network locations automatically upon the reading the card.

45. The system of claim 38 wherein the card for each user is the same as the card used for identification and access in a building security system.

46. The system of claim 31 wherein the user control interface comprises a software-implemented controller.

47. The system of claim 46 wherein the software-implemented controller includes a first icon that represents the at least one input device.

48. The system of claim 47 wherein the software-implemented controller further includes a second icon that represents the at least on output device.

49. The system of claim 48 wherein the first icon is movable to correspond with the second icon.

50. The system of claim 49 wherein the at least one of the input devices is connected with the output device when the first icon is moved to correspond to the second icon.

51. The system of claim 31 wherein the user control interface is accessible with a web browser.

52. The system of claim 31 wherein the processor is adapted to send signals to and receive signals from the at least two input devices and the at least one output device.

53. The system of claim 31 wherein the at least one output device comprises a projector.

54. The system of claim 31 wherein the at least on output device comprises lighting.

55. The system of claim 31 wherein at least one of the input devices comprises a video playback device.

56. The system of claim 31 wherein at least one of the input devices comprises a tablet personal computer.

57. The system of claim 31 wherein at least one input devices comprises a camera.

58. The system of claim 31 wherein at least one of the input devices and the output device are located in separate facilities.

59. The system of claim 31 wherein the processor is located in a facility separate from at least one of the at least one input device and the at least one output device.

60. The system of claim 31 wherein the user interface continuously displays an operating state of the at least two input devices and the output device.

61. The system of claim 31 further including at least one sensor connected with the processor.

62. The system of claim 61 wherein the sensor comprises an occupancy sensor.

63. The system of claim 61 wherein a function is initiated of at least one of the input devices and the output device when the occupancy sensor detects a presence.

64. The system of claim 31 wherein the processor accommodates a serial connection between the at least two input devices and the output devices.

65. The system of claim 31 further including a switching matrix connected with the processor that controls signals to the input devices and the at least one output device in accordance with instructions from the processor.

66. The system of claim 31 wherein functions of input devices and the at least one output device and connections of the input devices to the at least one output device are controlled upon the activation of one button.

67. The system of claim 31 wherein the output device comprises a printer.

68. The system of claim 31 wherein the processor is operable to automatically determine an available output device connectable with the input devices.

69. The system of claim 31 further including a video scaler connected between the input devices and the output devices.

70. The system of claim 69 wherein the input device comprises an analog video source and the output device comprises a red-green-blue output device.

71. The system of claim 69 wherein the processor automatically routes video from the selected input device through the video scaler only when required for video format compatibility with the at least one output device.

72. The system of claim 31 wherein the processor automatically updates when the input device and the output device is added to and removed from the control system.
